(19) United States
(12) Patent Application Publication
(10) Pub. No.: US 2025/0269569 A1
(43) Pub. Date: Aug. 28, 2025

(54) SPIRAL TANGLED FIBER COMPOSITES

(71) Applicant: CUMMINS INC., Columbus, IN (US)

(72) Inventors: Dale G. Gibby, Columbus, IN (US); Gregory A. Weber, Greensburg, IN (US)

(73) Assignee: CUMMINS INC., Columbus, IN (US)

(21) Appl. No.: 19/199,937

(22) Filed: May 6, 2025

Related U.S. Application Data
(63) Continuation of application No. PCT/US2023/036752, filed on Nov. 3, 2023.
(60) Provisional application No. 63/423,245, filed on Nov. 7, 2022.

(51) Int. Cl. B29C 45/00; B29B 9/14; B29K 105/12

(52) U.S. Cl. CPC B29C 45/0005; B29B 9/14; B29C 2045/0008; B29K 2105/12

(57) ABSTRACT

An injection-moldable composite pellet includes a matrix containing a polymer material and at least one fiber embedded within the matrix. The at least one fiber includes a first spiral shape and a composition different from that of the matrix. The first spiral shape comprises at least one loop spiraling around an axis.

### CROSS-REFERENCE TO RELATED APPLICATIONS

This application claims priority to and the benefit of U.S. Provisional Application No. 63/423,245, filed on Nov. 7, 2022, the content of which is incorporated by reference in its entirety.

### BACKGROUND

A composite (or composite material) is a material formed from at least two constituent materials to produce a material with improved physical and/or chemical properties. Composites are used in various applications involving lightweight and high-strength materials. For example, in the automotive industry, composites may be used to form oil pans, valve covers, intake manifolds, and various other components or parts. These components may be formed using an injection molding process by melting a pelletized material or another suitable feedstock of a composite material and injecting the melted composite material into a mold to form a desired shape comprising the composite material.

### SUMMARY

One aspect of the present disclosure relates to an injection-moldable composite pellet. The composite pellet includes a matrix containing a polymer material and at least one fiber embedded within the matrix. The at least one fiber includes a first spiral shape and a composition different from that of the matrix. The first spiral shape comprises at least one loop spiraling around an axis.

The first spiral shape may have a first length that extends linearly between a first end and a second end of the fiber along the axis, and the composite pellet may have a second length that is greater than the first length. The composite pellet may include a plurality of the fibers embedded within the matrix, where the fibers may be distributed evenly throughout the matrix. The first spiral shape may have a first length that extends linearly between a first end and a second end of the fiber along the axis, and the composite pellet may have a second length that is the same as the first length. The composite pellet may include a single fiber embedded within the matrix. The at least one fiber may include a recycled material. The at least one fiber may include fiberglass fibers, carbon fibers, or aramid fibers. The matrix may include a thermoplastic polymer material or a thermoset polymer material. The matrix may have a second spiral shape conforming to the first spiral shape and is formed as a coating that encapsulates the at least one fiber. The polymer material may be a first material having a first melting point and the at least one fiber may include a second material having a second melting point that is greater than the first melting point. The polymer material may be a first material having a first tensile strength and the at least one fiber may include a second material having a second tensile strength that is greater than the first tensile strength.

One aspect of the present disclosure relates to a composite material. The composite material includes a matrix comprising a polymer material and a plurality of fibers embedded within the matrix. The fibers each have a spiral shape and are entangled with one another to form a network within the matrix. The spiral shape includes at least one loop spiraling around a first axis. The fibers include a material different from the polymer material.

The spiral shape may include a diameter that extends linearly along a second axis perpendicular to the first axis and a length that extends linearly between a first end and a second end of the fiber along the first axis. The length may be greater than the diameter. The length is less than or equal to 10 mm. The fibers may include a first fiber having a first loop and a second fiber having a second loop, where the first loop may be interlaced with the second loop, causing the first fiber and the second fiber to be entangled with one another. The polymer material may be a first material having a first tensile strength and the at least one fiber may include a second material having a second tensile strength that is greater than the first tensile strength. The polymer material may be a first material having a first melting point and the at least one fiber may include a second material having a second melting point that is greater than the first melting point.

One aspect of the present disclosure relates to a method of forming a plurality of composite pellets. The method includes melting a fiber material. The method includes extruding the melted fiber material to form continuous fibers each having a spiral shape. The method includes shortening the continuous fibers to form a plurality of spiral-shaped fibers. The method includes mixing the spiral-shaped fibers with a matrix material to form a mixture, where the matrix material and the spiral-shaped fibers differ in composition. The method includes melting the mixture, causing the matrix material to encapsulate the spiral-shaped fibers. The method includes extruding the mixture to form an extrudate. The method includes shortening the extrudate to form the composite pellets each comprising at least one of the spiral-shaped fibers embedded in the matrix material.

A method of forming a composite part may include forming the composite pellets as described above. The method may include melting the composite pellets. The method may include injection-molding the melted composite pellets to form the composite part, causing the spiral-shaped fibers to entangle with one another within the matrix material.

### BRIEF DESCRIPTION OF THE FIGURES

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is an image demonstrating entanglement of a plurality of loosely-packed springs each having a spiral shape, according to an embodiment.

FIG. 2 is a schematic perspective view of an example structure of a spiral fiber, according to an embodiment.

FIGS. 3, 4, and 5 are each a schematic perspective view of an example structure of a composite pellet, according to various embodiments.

FIG. 6 is a flowchart of an example method of manufacturing spiral fibers such as that depicted in FIG. 2, according to an embodiment.

FIG. 7 is an image of an example material formed in a spiral shape, according to an embodiment.

FIG. 8 is a flowchart of an example method of manufacturing composite pellets such as those of FIG. 3, 4, or 5, according to an embodiment.

FIG. 9 is a flowchart of an example method of manufacturing an example composite part from the composite pellets manufactured by the example method of FIG. 8, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to a composite material and method of manufacture for a composite material. In particular, embodiments described herein relate to a pelletized composite feedstock for forming a composite material using an injection molding process. The various concepts introduced above and discussed in greater detail below may be implemented in any of numerous ways, as the described concepts are not limited to any particular manner of implementation. Examples of specific implementations and applications are provided primarily for illustrative purposes.

In one aspect, embodiments of the present disclosure provide an injection-moldable composite pellet. The composite pellet includes a matrix containing a polymer material and at least one fiber embedded within the matrix. The at least one fiber includes a first spiral shape and a composition different from that of the matrix. The first spiral shape comprises at least one loop spiraling around an axis.

The first spiral shape may have a first length that extends linearly between a first end and a second end of the fiber along the axis, and the composite pellet may have a second length that is greater than the first length. The composite pellet may include a plurality of the fibers embedded within the matrix, where the fibers may be distributed evenly throughout the matrix. The first spiral shape may have a first length that extends linearly between a first end and a second end of the fiber along the axis, and the composite pellet may have a second length that is the same as the first length. The composite pellet may include a single fiber embedded within the matrix. The at least one fiber may include a recycled material. The at least one fiber may include fiberglass, carbon fibers, or aramid fibers. The matrix may include a thermoplastic polymer material or a thermoset polymer material. The matrix may have a second spiral shape conforming to the first spiral shape and is formed as a coating that encapsulates the at least one fiber. The polymer material may be a first material having a first melting point and the at least one fiber may include a second material having a second melting point that is greater than the first melting point. The polymer material may be a first material having a first tensile strength and the at least one fiber may include a second material having a second tensile strength that is greater than the first tensile strength.

In another aspect, embodiments of the present disclosure provide a composite material. The composite material includes a matrix comprising a polymer material and a plurality of fibers embedded within the matrix. The fibers each have a spiral shape and are entangled with one another to form a network within the matrix. The spiral shape includes at least one loop spiraling around a first axis. The fibers include a material different from the polymer material.

The spiral shape may include a diameter that extends linearly along a second axis perpendicular to the first axis and a length that extends linearly between a first end and a second end of the fiber along the first axis. The length may be greater than the diameter. The length is less than or equal to 10 mm. The fibers may include a first fiber having a first loop and a second fiber having a second loop, where the first loop may be interlaced with the second loop, causing the first fiber and the second fiber to be entangled with one another. The polymer material may be a first material having a first tensile strength and the at least one fiber may include a second material having a second tensile strength that is greater than the first tensile strength. The polymer material may be a first material having a first melting point and the at least one fiber may include a second material having a second melting point that is greater than the first melting point.

In yet another aspect, embodiments of the present disclosure provide a method of forming a plurality of composite pellets. The method includes melting a fiber material. The method includes extruding the melted fiber material to form continuous fibers each having a spiral shape. The method includes shortening the continuous fibers to form a plurality of spiral-shaped fibers. The method includes mixing the spiral-shaped fibers with a matrix material to form a mixture, where the matrix material and the spiral-shaped fibers differ in composition. The method includes melting the mixture, causing the matrix material to encapsulate the spiral-shaped fibers. The method includes extruding the mixture to form an extrudate. The method further includes shortening the extrudate to form the composite pellets. The composite pellets each include at least one of the spiral-shaped fibers embedded in the matrix material.

A method of forming a composite part may include forming the composite pellets as described above. The method may include melting the composite pellets. The method may include injection-molding the melted composite pellets to form the composite part, causing the spiral-shaped fibers to entangle with one another within the matrix material.

Embodiments of the present disclosure provide a composite material having increased strength, toughness, and durability relative to existing composites without modifying the compositions of the materials used for a matrix and/or fibers included in the composite material. More specifically, embodiments of the present disclosure relate to a composite material that includes fibers having a curved, curly, helical, and/or spiral shapes. For purposes of simplicity, the fibers with a curved, curly, helical, and/or spiral shape may be referred to as “spiral fibers” hereafter, though the present disclosure does not limit the configurations of the fibers as such. The spiral fibers may each be formed in a shape of a coiled chain, for example, that includes a series of continuous loops (or turns).

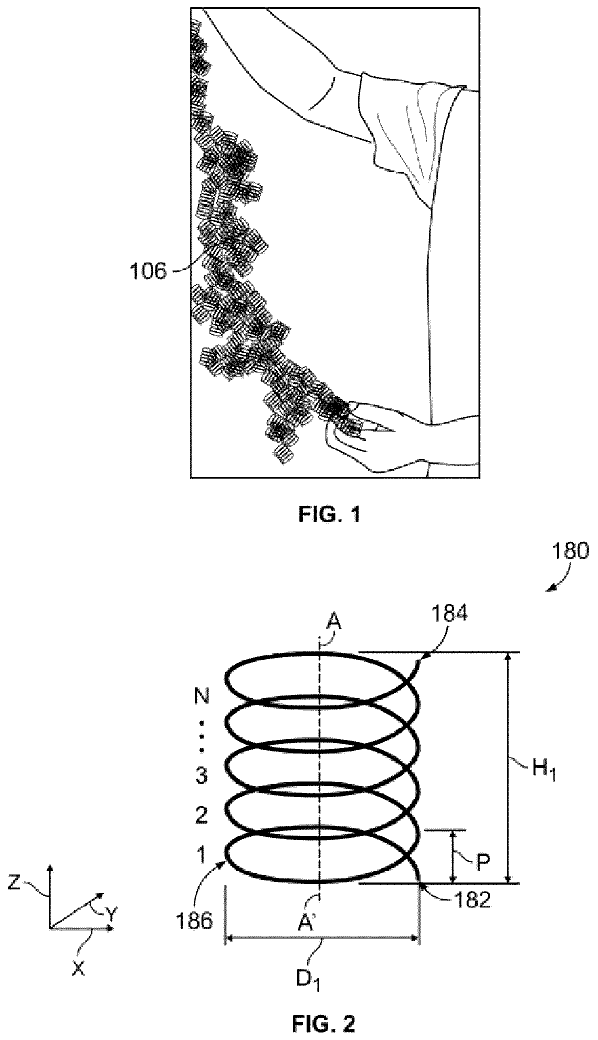

When molding a part (e.g., during the injection molding process, etc.) using the pelletized composite feedstock described herein, the matrix material melts and the spiral fibers can mobilize within the matrix when being pulled apart (e.g., due to natural movement of the fibers relative to one another and/or stress applied during the injection and/or the molding process, etc.). In various embodiments, the loops of the mobilized fibers become tangled (e.g., entangled, interlaced, interlocked, coupled, engaged, linked, intertwined, etc.) with one another to form a bundle or a network of spiral fibers, rendering separation of individual spiral fibers more difficult. In other words, the entanglement of the spiral fibers increases the spiral fibers' resistance to stress (e.g., tensile stress) applied to the composite material. An analogy of such mechanism can be shown in a bundle of loosely packed springs 106 that become tangled with one another when stress is applied to pull the bundle apart, as shown in FIG. 1.

The entanglement or interlacing of the spiral fibers increases resistance for the spiral fibers to slide past one another and/or through the matrix when forces (e.g., stresses) are applied to form (e.g., injecting and molding) the part. For a formed (e.g., injection-molded) part containing a fiber-reinforced composite material, the fibers of the composite will need to physically break for the formed part to fracture and/or fail. In this regard, an increase in resistance to sliding due to the entanglement of the spiral fibers described herein increases the stress (e.g., tensile stress) needed to break the spiral fibers in the composite material, resulting in a stronger composite material (e.g., having increased tensile strength) in comparison to a composite material having un-tangled (e.g., separated, parallel, etc.) and/or straight fibers embedded in the matrix. In other words, the strength of the composite material can be improved by altering the structure of the fibers without changing the composition of the fibers and/or the matrix. Accordingly, mechanical properties of the formed part can be enhanced without significantly changing the composition of the composite material or the fabrication process thereof.

In some embodiments, the present disclosure provides a feedstock used in an injection molding process. The feedstock includes a plurality of pellets that can be melted and molded by the injection molding process to form a part or component that includes the composite material described herein. In this regard, the pellets are alternatively referred to as composite pellets hereafter. In various embodiments, each pellet includes at least one of the spiral fibers embedded in a matrix material, where the fibers and the matrix material differ in composition and mechanical properties.

Referring to FIG. 2, pellets (e.g., pellets 200, 300, and 400 described below) of the composite material may include at least one fiber 180 formed in a spiral shape. For example, the fiber 180 spirals around a central axis AA′ (e.g., along the Z axis) over a distance defined as a length (or height) H1 that linearly extends from a first end (e.g., a bottom end) 182 to a second end 184 (e.g., a top end) along the central axis AA′. The fiber 180 is also defined by a diameter D1 that linearly extends along a direction (e.g., along the X axis) perpendicular to the central axis AA′. In some embodiments, the length H1 is greater than the diameter D1, such that the fiber 180 is elongated along the central axis AA′. In some embodiments, the fiber 180 occupies a volume that resembles that of a cylinder having the diameter D1 and the length H1. In this regard, the diameter D1 and the length H1 can be used independently or collectively to describe a size of the fiber 180. In some embodiments, both the diameter D1 and the length H1 are on a scale of millimeter or sub-millimeter, while their specific values can vary according to sizes of the pellets in which they are incorporated, as described below.

In addition, the fiber 180 includes a plurality of continuous loops (e.g., turns) 186 spaced along the central axis AA′ by a pitch P. A number N of the loops 186 can be any positive integer greater than or equal to 1, such as 2, 3, 8, or 11, etc. Accordingly, the pitch P is defined as a ratio of the length H1 and the number N. In some embodiments, increasing the number N of each fiber 180 increases a likelihood of forming a tangled network of fibers 180 during an injection molding process as each additional loop 186 in one fiber 180 provides an additional entanglement site with an adjacent fiber 180. However, the number N should not be too large (for a given length H1, for example) such that the pitch P is below a threshold value corresponding to a spacing that allows the insertion of a loop 186 from an adjacent fiber 180. In some embodiments, the diameter D also influences the degree of entanglement between a plurality of fibers 180. In some embodiments, for a given length H1 of the fiber 180, the diameter D, the number N, and/or the pitch P, are determined empirically. In some embodiments, the loops 186 are spaced apart at varying, rather than equal, distances, such that the pitch P varies along the central axis AA′. In some embodiments, the fiber 180 includes a first section having a series of loops 186 connected in series and a second section that is substantially straight, i.e., without any loops 186.

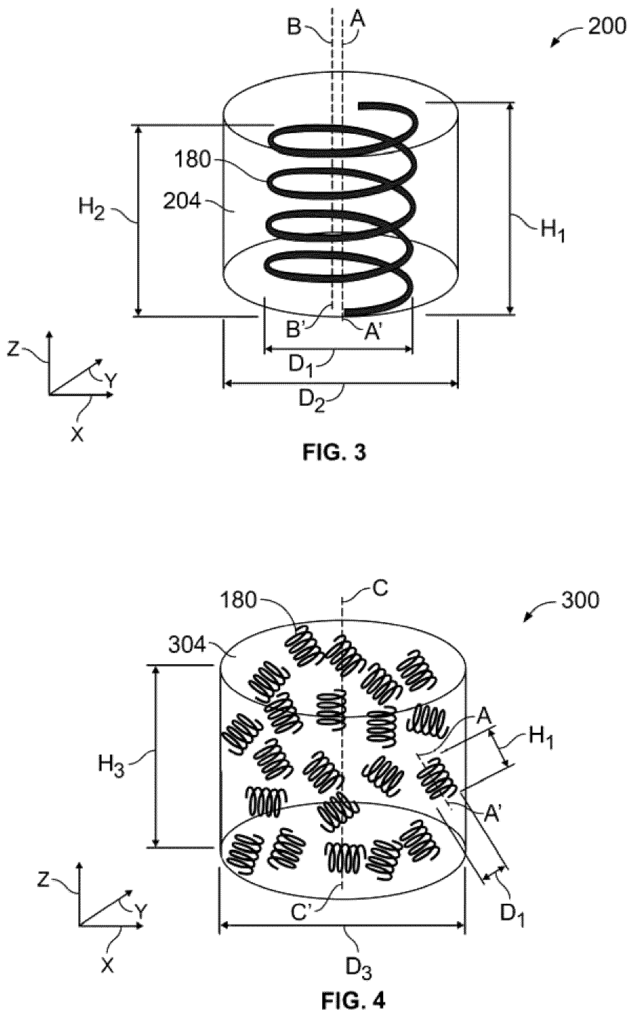

In some embodiments, each individual pellet provided herein includes the fiber 180, or a plurality thereof, positioned or otherwise disposed within a matrix material (e.g., a polymer matrix material), such that when a plurality of such pellets are melted and subjected to an injection molding process, the fibers 180 interlace, interlock, couple, engage, link, or interwind with one another so as to increase a degree of entanglement between the fibers 180. In at least one embodiment, as shown in FIG. 3, a pellet 200 of composite material may include only a single fiber 180 embedded within a matrix material 204. In some embodiments, a size of the fiber 180 (e.g., a length, a diameter, etc.) may be similar to an overall size of the pellet 200. For example, the length H1 of the fiber 180 and a length (or height) H2 of the pellet 200 linearly extending along a central axis BB′ (e.g., along the Z axis) may be approximately the same, and the diameter D1 may be at least about 50% of a diameter D2 of the pellet 200. In some embodiments, the diameter D1 is approximately the same as the diameter D2.

In some embodiments, the fiber 180 is positioned within the pellet 200 such that the central axis AA′ of the fiber 180 and the central axis BB′ of the pellet 200 are aligned with one another, as depicted in FIG. 3. In some embodiments, the fiber 180 is positioned in the pellet such that the central axis AA′ is angled from the central axis BB′. In this regard, the length H1 of the fiber 180 may be greater than the length H2 of the pellet 200. In some examples, the length H2 of the pellet 200 may range from approximately 5 mm to approximately 10 mm, inclusive. Accordingly, the length H1 of the single fiber 180 in the pellet 200 is at least on the order of sub-millimeter but does not exceed approximately 10 mm.

In another embodiment, as shown in FIG. 4, a pellet 300 may include a plurality of fibers 180 embedded within a matrix material 304. The pellet 300 has a diameter D3 and a length (or height) H3 linearly extending along a central axis CC′ (e.g., along the Z axis). As depicted, the diameter D3 is greater than the diameter D1, and the length H3 is greater than the length H1. For example, the diameter D1 and the length H1 of the fibers 180 may be less than or equal to approximately one fourth, one fifth, one sixth, one tenth, or any other desired size, depending on application requirements, of the diameter D3 and the length H3, respectively.

In some embodiments, the fibers 180 are evenly distributed throughout the matrix material 304. In some embodiments, the fibers 180 are oriented in various directions with respect to the central axis CC′. In some embodiments, the pellet 300 includes fibers 180 of different sizes (e.g., different heights and different diameters). In some examples, the length H3 of the pellet 300 may range from approximately 5 mm to approximately 10 mm, inclusive. Accordingly, the length H1 of each of the plurality of fibers 180 in the pellet 300 is at least on the order of sub-millimeter but does not exceed approximately 10 mm.

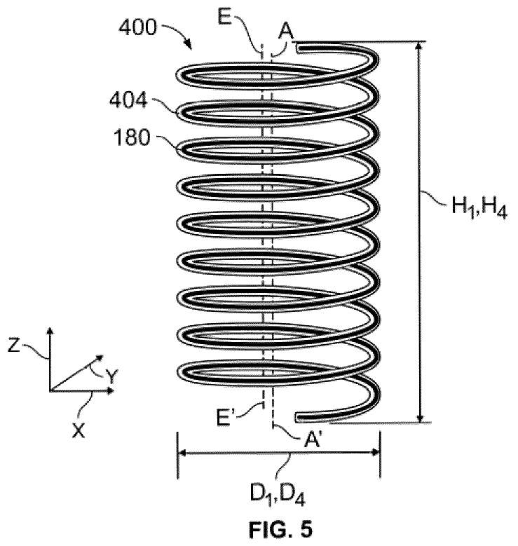

In yet other embodiments, and as shown in FIG. 5, a pellet 400 may be formed in a spiral shape that corresponds with or conforming to or is approximately the same as a shape of a single fiber 180 embedded within a matrix material 404. In this regard, the matrix material 404 may be formed as a coating that encapsulates the single fiber 180. In some embodiments, portions of the matrix material 404 coalesce or merge to fill, in parts or entirety, an gap between two adjacent loops 186. The pellet 400 has a diameter D4 and a length (or height) H4 linearly extending along a central axis EE′ (e.g., along the Z axis). As depicted, the diameter D4 is approximately the same as the diameter D1, and the length H3 is approximately the same as the length H1. In some examples, the length H4 of the pellet 300 may range from approximately 5 mm to approximately 10 mm, inclusive. Accordingly, the length H1 of the single fiber 180 in the pellet 400 is at least on the order of sub-millimeter but does not exceed approximately 10 mm.

It should be appreciated that various fiber and/or matrix geometries may be used in the composite material. For example, the fibers may be formed in any shape that is configured to entangle with one another. In the embodiments of FIGS. 3-5, a diameter and/or a pitch of the spiral shape of the fibers may be varied depending on application requirements.

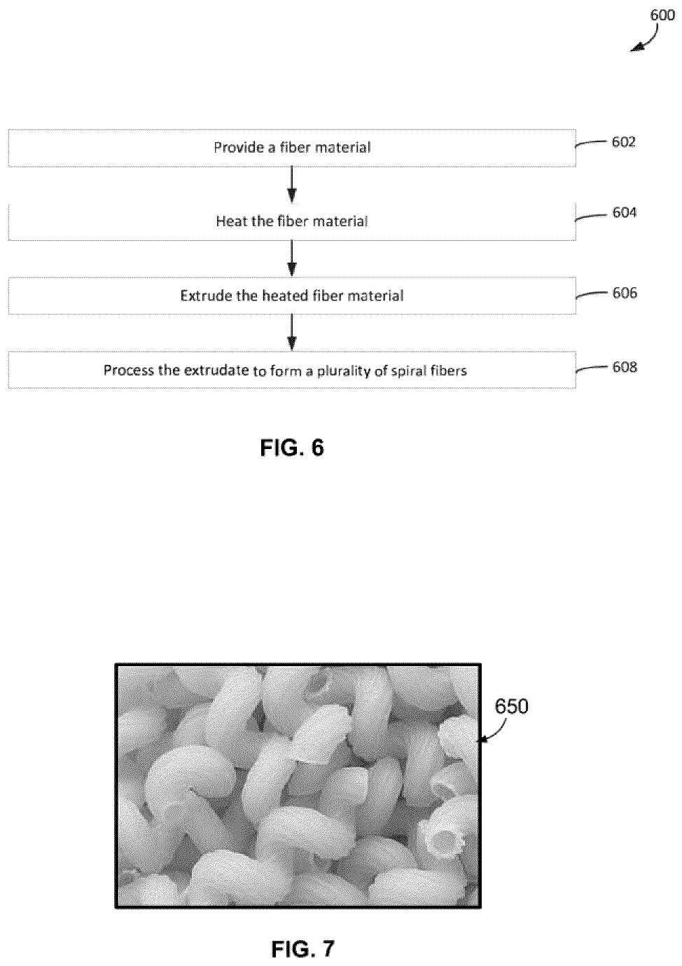

A method 600 of manufacturing spiral fibers for a composite material is depicted in FIG. 6. It is noted that the method 600 is merely an example and is not intended to limit the present disclosure. Accordingly, additional operations may be provided before, during, and after the method 600 of FIG. 6.

The method 600 at operation 602 includes providing a fiber material including fiberglass, elemental carbon, polymers (e.g., polyamide), other suitable materials, or combinations thereof. The fiber material may include a virgin fiber material or a recycled fiber material. For example, the operation 602 may be implemented as a part of a recycling operation for carbon fibers, fiberglass fibers, aramid (e.g., polyamide) fibers, or another fiber material. The method 600 at operation 604 includes heating and/or melting the fiber material.

The method 600 at operation 606 includes extruding the heated and/or melted fiber material to produce fibers of a curved, curly, and/or spiral shape, such as the spiral shape of the fiber 180 described herein. For example, the method 600 at the operation 606 may include extruding the heated and/or melted fiber material by pressing the fiber material through an opening (e.g., a hole, an orifice, a die, etc.) of an extruder. The opening may be structured to produce an extrudate that includes a plurality of continuous fibers having the spiral shape, where a length of the continuous fibers may be determined based on an amount of the fiber material being extruded.

In at least one embodiment, an inner surface of the opening includes on a first portion having a rougher geometry or texture for providing greater resistance to extrusion than a second portion connected to and opposing the first portion so as to result in an asymmetrical flow of the continuous fibers through the opening. Such asymmetrical flow causes the continuous fibers to spiral around an axis (e.g., the central axis AA′ of the fiber 180). In an example embodiment, the method 600 at the operation 606 produces spiral-shaped fibers, such as the fiber 180. In this regard, the fibers produced at the operation 606 each include one or more continuous loops, such as the loops 186, connected in series along the axis. In some embodiments, the method 600 at operation 606 produces fibers of different shapes and sizes (e.g., diameter and length or height). In some embodiments, the heating and/or melting at the operation 604 and the extruding at the operation 606 are implemented in the same equipment and in a simultaneous manner.

The method 600 at operation 608 includes subsequently processing, by way of cutting or otherwise shortening, the continuous fibers to form discontinuous fibers each having a spiral shape and sizes (e.g., diameter and length) similar to those of the fibers 180 described herein. In some embodiments, the length (or height) of the spiral fibers does not exceed 10 mm, which is the height (or length) of any of the pellet 200, 300, or 400 described herein. In some embodiments, the resulting spiral fibers have a structure analogous to structures 650 formed by a food extrusion process as shown in FIG. 7.

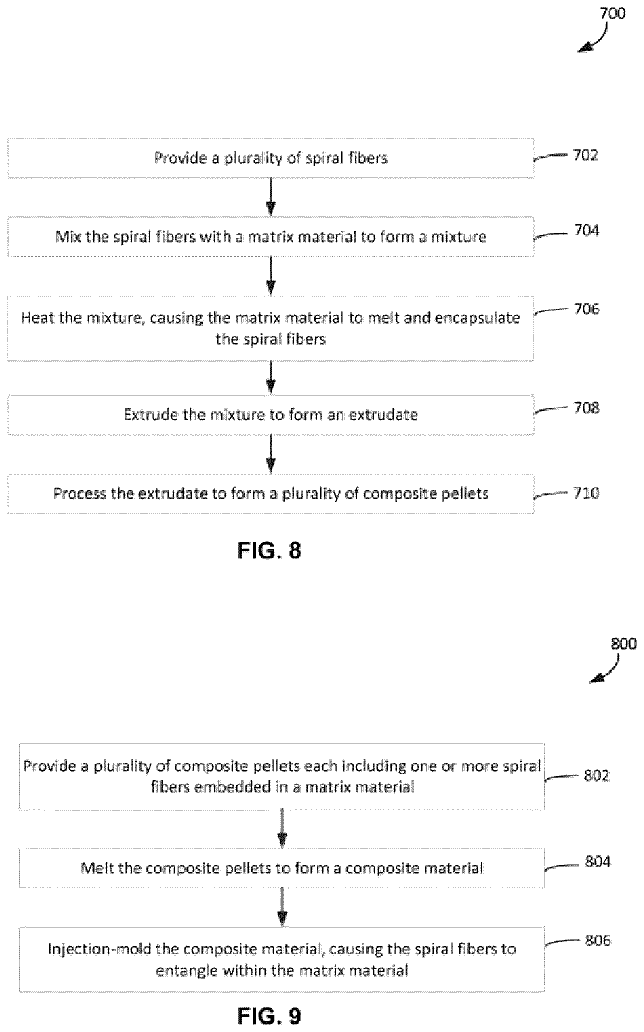

A method 700 of manufacturing composite pellets, each including at least one spiral fiber formed by the method 600 described herein, for an injection molding process is depicted in FIG. 8. It is noted that the method 700 is merely an example and is not intended to limit the present disclosure. Accordingly, additional operations may be provided before, during, and after the method 700 of FIG. 8.

The method 700 at operation 702 includes providing (or forming) a plurality of spiral (e.g., curved, curly, and/or helical) fibers, such as the fibers 180 described herein. The plurality of spiral fibers can be manufactured by a suitable process, such as that of the method 600 depicted in FIG. 6. The method 700 at operation 704 includes mixing the spiral fibers into a matrix material (e.g., a nylon material, etc.) to form a mixture.

In some embodiments, the matrix material includes a first material and the spiral fibers include a second material different from the first material, i.e., the fibers and the matrix material have different compositions. In one example, the first material may include a polymer (e.g., organic) material and the second material may include an inorganic material. In another example, the first material and the second material each include a polymer material. In some embodiments, the second material has a higher strength (e.g., tensile strength) than the first material. In some embodiments, the second material has a higher melting point than the first material. In some embodiments, the first material includes a thermoplastic polymer material, a thermoset polymer material, or a combination thereof. For example, the first material may include a polyamide (e.g., nylon). In some embodiments, the second material includes glass (e.g., glass fibers), elemental carbon (e.g., carbon fibers), polyamide (e.g., aramid fibers), other suitable fiber materials, or combinations thereof.

The method 700 at operation 706 includes heating the mixture to melt the matrix material, which subsequently encapsulates or embeds the spiral fibers. In some embodiments, the heating of the mixture is implemented at a temperature that is at least the melting point of the matrix material (i.e., the first material) but is less than the melting point of the spiral fibers (i.e., the second material).

The method 700 at operation 708 includes extruding the mixture to form an extrudate having the fibers embedded in the matrix material. The method 700 at operation 710 includes subsequently processing, by way of cutting or otherwise shortening, the extrudate to form a plurality of composite pellets, such as the pellets 200, 300, or 400 described herein. In some embodiments, the composite pellets are formed to have a height (or length) in a range of approximately 5 mm to approximately 10 mm, inclusive. In some embodiments, the spiral fibers, after being shortened at the operation 608, are further shortened at the operation 708. The resulting composite pellets each include at least one spiral fiber embedded in the matrix material. In one example, the composite pellets may each include at least one spiral fiberglass fibers embedded in a nylon matrix. In another example, the composite pellets may each include at least one spiral carbon fibers embedded in a thermoset matrix. In yet another example, the composite pellets may each include at least one spiral aramid fibers embedded in a thermoset matrix.

A method 800 of performing an injection molding process to form a composite part using a pelletized feedstock is depicted in FIG. 9. It is noted that the method 800 is merely an example and is not intended to limit the present disclosure. Accordingly, additional operations may be provided before, during, and after the method 800 of FIG. 9.

The method 800 at operation 802 includes providing (or forming) a pelletized feedstock containing a plurality of composite pellets, such as the pellets 200, 300, or 400 described herein, where the composite pellets each include at least one spiral (e.g., curved, curly, and/or helical) fibers, such as the fibers 180, embedded in a matrix material, such as the matrix material 204, 304, or 404. The spiral fibers and the composite pellets can be manufactured by a suitable process, such as the methods 600 and 700, respectively, described herein.

The method 800 at operations 804 and 806 collectively includes melting the composite pellets and subsequently injection-molding the melted composite pellets to form the composite part having any desired size and shape according to application requirements. In some embodiments, the process of injection-molding the melted composite pellets causes the spiral fibers in the composite pellets to entangle (e.g., couple, engage, interlace, link, interwind, interlock, etc.) with one another, forming a bundle or network of tangled (e.g., interlaced, interlocked, coupled, engaged, linked, intertwined, etc.) spiral fibers in the matrix material of the resulting composite part. In some embodiments, loops, such as the loops 186 of the fiber 180, of one spiral fiber penetrate and interlace with loops of adjacent spiral fibers, causing the entanglement between the spiral fibers. In some embodiments, the tangled spiral fibers require greater force to be physically separated and broken than un-tangled (e.g., separated, parallel, etc.) and/or straight fibers. Accordingly, the strength (e.g., the tensile strength) of the overall composite material, thus the resulting composite part, is enhanced without altering the composition of the components (e.g., the fibers and the matrix material) of the composite material.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As used herein, the terms “about” and “approximately” generally mean plus or minus 5% of the stated value. For example, about 0.5 would include 0.475 and 0.525, about 10 would include 9.5 to 10.5, about 1000 would include 950 to 1050.

As used herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed (e.g., within plus or minus five percent of a given angle or other value) are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the embodiments described herein.

While this specification contains many specific implementation details, these should not be construed as limitations on the scope of any embodiment or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. An injection-moldable composite pellet, comprising:
a matrix comprising a polymer material; and
at least one fiber embedded within the matrix, the at least one fiber having a first spiral shape and a composition different from that of the matrix, the first spiral shape comprising at least one loop spiraling around an axis.

2. The composite pellet of claim 1, wherein the first spiral shape has a first length that extends linearly between a first end and a second end of the fiber along the axis, and wherein the composite pellet has a second length that is greater than the first length.

3. The composite pellet of claim 2, comprising a plurality of the fibers embedded within the matrix, wherein the fibers are distributed evenly throughout the matrix.

4. The composite pellet of claim 1, wherein the first spiral shape has a first length that extends linearly between a first end and a second end of the fiber along the axis, and wherein the composite pellet has a second length that is the same as the first length.

5. The composite pellet of claim 4, comprising a single fiber embedded within the matrix.

6. The composite pellet of claim 1, wherein the at least one fiber comprises a recycled material.

7. The composite pellet of claim 1, wherein the at least one fiber comprises fiberglass fiber, carbon fibers, or aramid fibers.

8. The composite pellet of claim 1, wherein the matrix comprises a thermoplastic polymer material or a thermoset polymer material.

9. The composite pellet of claim 1, wherein the matrix has a second spiral shape conforming to the first spiral shape.

10. The composite pellet of claim 9, wherein the matrix is formed as a coating that encapsulates the at least one fiber.

11. The composite pellet of claim 1, wherein the polymer material is a first material having a first melting point and the at least one fiber comprises a second material having a second melting point that is greater than the first melting point.

12. The composite pellet of claim 1, wherein the polymer material is a first material having a first tensile strength and the at least one fiber comprises a second material having a second tensile strength that is greater than the first tensile strength.

13. A composite material, comprising:
a matrix comprising a polymer material; and
a plurality of fibers embedded within the matrix, the fibers each having a spiral shape and entangled with one another to form a network within the matrix, the spiral shape comprising at least one loop spiraling around a first axis, and the fibers comprising a material different from the polymer material.

14. The composite material of claim 13, wherein the spiral shape has a diameter that extends linearly along a second axis perpendicular to the first axis and a length that extends linearly between a first end and a second end of the fiber along the first axis, and wherein the length is greater than the diameter.

15. The composite material of claim 14, wherein the length is less than or equal to 10 mm.

16. The composite material of claim 14, wherein the fibers comprise a first fiber having a first loop and a second fiber having a second loop, and wherein the first loop is interlaced with the second loop, causing the first fiber and the second fiber to be entangled with one another.

17. The composite material of claim 13, wherein the polymer material is a first material having a first tensile strength and the at least one fiber comprises a second material having a second tensile strength that is greater than the first tensile strength.

18. The composite material of claim 13, wherein the polymer material is a first material having a first melting point and the at least one fiber comprises a second material having a second melting point that is greater than the first melting point.

19. A method of forming a plurality of composite pellets, comprising:
melting a fiber material;
extruding the melted fiber material to form continuous fibers each having a spiral shape;
shortening the continuous fibers to form a plurality of spiral-shaped fibers;
mixing the spiral-shaped fibers with a matrix material to form a mixture, the matrix material and the spiral-shaped fibers differing in composition;
melting the mixture, causing the matrix material to encapsulate the spiral-shaped fibers;
extruding the mixture to form an extrudate; and
shortening the extrudate to form the composite pellets each comprising at least one of the spiral-shaped fibers embedded in the matrix material.

20. A method of forming a composite part, comprising:
forming the composite pellets according to claim 19;
melting the composite pellets; and
injection-molding the melted composite pellets to form the composite part, causing the spiral-shaped fibers to entangle with one another within the matrix material.
